(19) United States
(12) Patent Application Publication
(10) Pub. No.: US 2005/0079254 A1
(43) Pub. Date: Apr. 14, 2005

(54) Method for reducing acrylamide in foods, foods having reduced levels of acrylamide, and article of commerce

(75) Inventor: Patrick Joseph Corrigan, Cincinnati, OH (US)

Correspondence Address: THE PROCTER & GAMBLE COMPANY;INTELLECTUAL PROPERTY DIVISION, WINTON HILL TECHNICAL CENTER - BOX 161, 6110 CENTER HILL AVENUE, CINCINNATI, OH, 45224, US

(73) Assignee: The Procter & Gamble Company

(21) Appl. No.: 10/811,603

(22) Filed: Mar. 29, 2004

Related U.S. Application Data
(60) Provisional application No. 60/510,567, filed on Oct. 10, 2003.
(60) Provisional application No. 60/540,942, filed on Jan. 29, 2004.

(51) Int. Cl. C12H 1/04

(52) U.S. Cl. 426/271

(57) ABSTRACT

A method for the reduction of acrylamide in food products, food products having reduced levels of acrylamide, and an article of commerce. In one aspect, the method comprises adding to a food material a multivalent cation, in one embodiment a water-soluble, non-chelated multivalent cation. In yet another aspect, an article of commerce communicates to the consumer that a food product has reduced or low levels of acrylamide.

### CROSS REFERENCE TO RELATED APPLICATIONS

This application claims the benefit of priority to U.S. Provisional Application Ser. No. 60/510,567, filed Oct. 10, 2003, and to U.S. Provisional Application Ser. No. 60/540,942, filed Jan. 29, 2004, all of which are herein incorporated by reference.

### FIELD OF INVENTION

The present invention relates to the reduction of acrylamide in food products and to food products having reduced levels of acrylamide. The invention further relates to an article of commerce.

### BACKGROUND OF THE INVENTION

Since the dawn of civilization, carbohydrate-containing foods have been a staple in man's diet. Today, carbohydrate-containing foods such as breads, breakfast cereals, biscuits, crackers, cookies, French fries, cooked starchy vegetables, taco shells, and snack foods are popularly consumed. Although such foods have been part of the human diet for countless years, researchers have only recently discovered that many of these foods contain acrylamide.

In April 2002, the Swedish National Food Administration and researchers from Stockholm University announced their findings that acrylamide, a potentially cancer-causing chemical, is formed in many types of cooked foods. Acrylamide has a carcinogenic potency in rats that is similar to that of other carcinogens in food, but for humans, the relative potency in food is not known. Only limited human population data are available for acrylamide and these provide no evidence of cancer risk from occupational exposure. (FAO/WHO Consultation on the Health Implications of Acrylamide in Food: Summary Report; Geneva, Switzerland, 25-27 Jun. 2002.)

Although further research is needed to assess what health effects, if any, may result from human consumption of acrylamide at the levels commonly found in such foods, many consumers have voiced concern. Accordingly, it is an object of the present invention to provide a method for reducing the level of acrylamide in foods. It is also an object of the present invention to provide food products having reduced levels of acrylamide. Further, it is an object of the present invention to provide an article of commerce that communicates to the consumer that a food product has reduced or low levels of acrylamide.

### SUMMARY OF THE INVENTION

In one aspect, the present invention provides a method for reducing the level of acrylamide in a food product. In one embodiment, the method comprises adding a multivalent cation to a food material before heating. In a particular embodiment, the multivalent cation is a multivalent cation.

In another aspect, the present invention provides a method for reducing the level of acrylamide by complexing asparagine and/or products of the reaction of asparagine and reducing sugar with a multivalent cation. In one embodiment, the method comprises adding a multivalent cation to the food material before heating.

In another aspect, the present invention provides food products having reduced levels of acrylamide.

In yet another aspect, the present invention provides an article of commerce that communicates to the consumer that a food product has reduced or low levels of acrylamide.

All percentages herein are by weight unless otherwise specified.

As used herein, “ppb” means parts per billion by weight.

All documents cited herein are, in relevant part, incorporated herein by reference; the citation of any document is not to be construed as an admission that it is prior art with respect to the present invention.

### BRIEF DESCRIPTION OF THE DRAWINGS

FIG. 1. FIG. 1 sets forth the proposed reaction mechanism by which acrylamide forms from asparagine and a carbonyl source (such as glucose). R₁ and R₂ can ═H, CH₃, CH₂OH, CH₂(CH₂)ₙCH₃, or any other component making up a reducing sugar; n can be any integer less than 10.

### DETAILED DESCRIPTION OF THE INVENTION

It has been discovered that asparagine, a naturally occurring amino acid found in virtually all living systems, can form acrylamide when heated. Thus, foods richer in asparagine, when heated, tend to contain higher levels of acrylamide; this is especially the case when asparagine-containing foods are heated in the presence of reducing sugars. Formation of acrylamide has also been found to be higher when foods are cooked to a lower final moisture content.

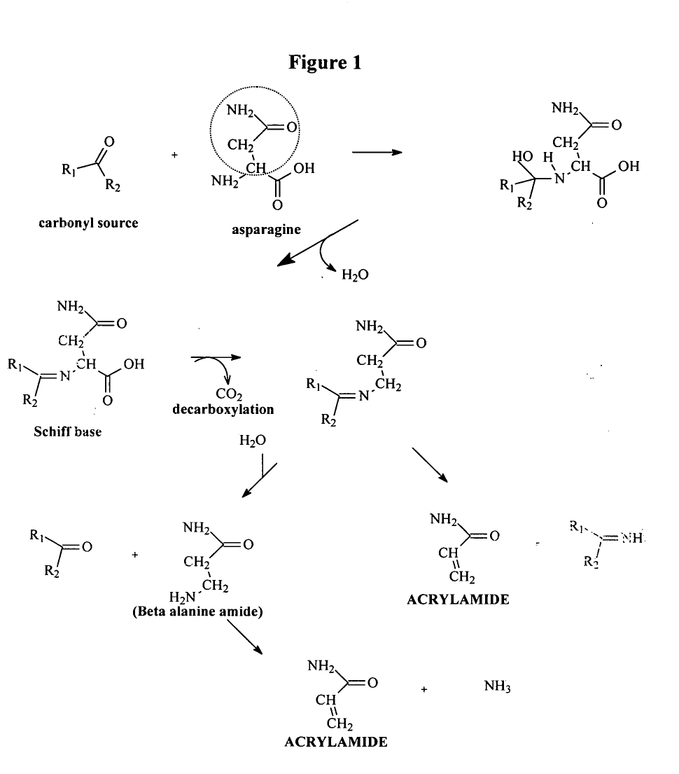

While not being limited by theory, it is believed that acrylamide forms in food products via the reaction mechanism set forth in FIG. 1. It is believed that the alpha-amine group of free asparagine reacts with a carbonyl source, forming a Schiff base. Under heat, the Schiff base adduct decarboxylates, forming a product that can either: (1) hydrolyze to form beta-alanine amide (which can, under heat, further degrade to form acrylamide) or (2) decompose to form acrylamide and the corresponding imine. (It has been discovered that the circled precursor atoms comprise the carbons and nitrogens in acrylamide.)

It has been further discovered that acrylamide formation in heated foods can be reduced by adding a multivalent cation before cooking. For instance, trivalent cations such Al⁺³ (aluminum) and divalent cations such as Ca⁺² (calcium), Mg⁺2 (magnesium), Zn⁺2 (zinc), and Cu⁺² (copper) may be used alone on in combination. It is preferred that the multivalent cation have an associated anion that facilitates the cation's solubility in water. It is also preferred that the corresponding anion be of a type that will not complex with, chelate, or otherwise bind with the cation so as to make it unavailable for use as an acrylamide reaction suppressing agent. When such foods containing multivalent cations are heated, the amount of acrylamide formed is reduced.

While not being limited by theory, it is believed that the added multivalent cation complexes with asparagine and/or products of the reaction of asparagine and reducing sugar, thus preventing the formation of acrylamide. Preferred cations for use in the method herein include, but are not limited to, Al⁺³ (aluminum), Ca⁺² (calcium), Mg⁺² (magnesium), Zn⁺² (zinc), and Cu⁺² (copper), either alone or in combination. However, any multivalent cation capable of complexing with free asparagine and/or products of the reaction of asparagine and reducing sugar to prevent the formation of acrylamide is within the scope of the present invention.

The advantages of using multivalent cations in food processing are numerous. These advantages include: (a) they generally suppress the acrylamide reaction without causing unwanted side reactions; (c) they are active under very mild conditions of temperature and pH; (d) they are active at low concentrations; (e) some multivalent cations such as calcium are already widely approved for use in food processing.

A. Method for Reduction of Acrylamide in Food Products

In one aspect, the present invention provides a method for the reduction of acrylamide in food products. In one embodiment, the method comprises adding a water-soluble, uncomplexed multivalent cation to a food material before final heating (e.g., cooking). A preferred cation is calcium. Preferred forms of calcium include calcium lactate and calcium chloride, either in solid or liquid (e.g., in solution) form.

In another aspect, the present invention provides a method for reducing the level of acrylamide by complexing asparagine and/or products of the reaction of asparagine and reducing sugar with a multivalent cation. In one embodiment, the method comprises adding a multivalent cation to the food material before heating.

In a preferred embodiment, the present invention provides a method for reducing the level of acrylamide in food, comprising:
(1) adding a multivalent cation to a food material, wherein said food material comprises asparagine;
(2) optionally mixing the cation with the food material;
(3) allowing a sufficient time for the cation to complex; and
(4) heating the food material to form the finished food product.

1. Adding a Multivalent Cation to a Food Material Wherein said Food Material Comprises Asparagine

As used herein, “multivalent cation” means any cation with a valence greater than one. Furthermore, “multivalent cation” includes any multivalent cation capable of complexing with asparagine and/or products of the reaction of asparagine and reducing sugar in a food product. A preferred cation is calcium. Preferred salts of calcium include calcium lactate and calcium chloride.

As used herein, the terms “multivalent cation,” “cation,” “the multivalent cation,” and “the cation” include one or more multivalent cations; for example, a mixture of two or more multivalent cations is encompassed by the terms.

As used herein, the term “food” is broad enough to include both foods and beverages.

As used herein, “food material” includes, but is not limited to, any edible material used in the preparation of food or beverage products, including mixtures of two or more foods or beverages. “Food material” includes any type of asparagine-containing food, food product, food ingredient, beverage, beverage product, beverage ingredient, or mixtures thereof. The food material can be in any suitable form, including raw or pre-treated. Suitable methods of pre-treating the food material include, but are not limited to, blanching, steaming, boiling, chopping, macerating, comminuting, reducing the particle size, drying with heat, and combinations thereof.

The multivalent cation may be added to the food material in any suitable form. For instance, the multivalent cation may be added as a powder or in the form of a solution. Furthermore, the multivalent cation may be added to the food material in any suitable manner, such as directly (for example, sprinkled, poured, or sprayed on the food material) or indirectly. In one embodiment, the multivalent cation is admixed with a food that does not contain asparagine, then the resulting mixture is added to the asparagine-containing food.

In another embodiment, at least a portion of the asparagine is extracted from the food material, the resulting extract is treated with the multivalent cation, then at least a portion of the extract is added back into at least a portion of the food material; for example, the multivalent cation may be added to a stream, or a stream may be pumped through a bed or column of cationic resin, where the cationic species comprises the multivalent cation.

As used herein, “adding” the multivalent cation to the food material includes, but is not limited to, any means of bringing the asparagine and the multivalent cation together.

In one embodiment, a water soluble multivalent cation is added via dissolving a water insoluble multivalent cation compound in an acid to form the water soluble cation. In a particular embodiment, a water soluble divalent cation (calcium lactate) is formed by dissolving calcium hydroxide in lactic acid to form calcium lactate. The insoluble cation and the acid can be added to the food material in any suitable manner. For instance, the insoluble cation and the acid can be added separately to the food material, or they can be combined then added together to the food material.

The multivalent cation may be added to the food material at any suitable stage of the method. For example, the multivalent cation may be added with the other ingredients during the mixing of a dough. In one embodiment, the multivalent cation can be added to a food material before, during, or after maceration.

The effective amount of multivalent cation required to achieve the desired level of acrylamide reduction in the finished food product will depend upon the complexing ability of the particular multivalent cation used.

The amount of multivalent cation to add can depend upon the level of asparagine complexation and/or complexation of products of the reaction of asparagine and reducing sugar, and accordingly the level of acrylamide reduction, that is desired. The amount of multivalent cation to add can also depend upon the amount of asparagine present in the food material; food materials higher in asparagine will generally require increased levels of multivalent cation or increased reaction time to achieve the same level of acrylamide reduction. The amount of multivalent cation to add can also depend upon the particular multivalent cation used (for example, the particular cation's ability to complex with asparagine) and the particular food material treated. One skilled in the art will be able to determine the effective amount of cation based upon the specific food material, the specific cation, the cation's specific activity, and the desired result.

In one embodiment, at least one mole of calcium ion is added per mole of free asparagine in the food material, more preferably at least two moles, and most preferably at least three moles.

As used herein, “free asparagine” or “asparagine” refers to that form of asparagine that is not an element of a peptide, but is a free-standing amino acid.

2. Optionally Mixing the Multivalent Cation with the Food Material

Optionally but preferably, the multivalent cation is thoroughly mixed with the food material. Any suitable method of mixing can be used. In one embodiment, mixing is carried out simultaneously with the maceration of the food material and the addition of the cation. In another embodiment, the cation is dissolved in water prior to addition to the food material.

3. Allowing a Sufficient Time for the Multivalent Cation to Complex

The amount of time needed for the cation to complex with the asparagine and/or products of the reaction of asparagine and reducing sugar will depend upon factors including, but not limited to, the desired level of acrylamide reduction, the characteristics of the particular food material (e.g., chemical composition, amount of asparagine present, particle size), and the particular cation added. The step of allowing a sufficient time for the cation to react can be carried out in any suitable manner; for example, it can be carried out simultaneously with adding the cation to the food material, mixing the cation with the food material, or combinations thereof.

As known in the art, pH and temperature are factors that affect complexing of cations. One skilled in the art should readily be able to determine optimal conditions of these and other parameters (e.g., water content). In addition, optimal pH and temperature conditions for specific cations are typically available in the literature.

4. Heating the Food Material to Form the Finished Food Product

The food material can then be heated in the usual manner, such as by baking, frying, extruding, drying (e.g., via vacuum oven or drum dryer), puffing, or microwaving. At least a portion of the cation may be added to the food material during the heating step. At least a portion of the cation may also be added to the food material immediately following the heating step.

As used herein, the term “finished food product” or “food product” includes, but is not limited to, foods and beverages ready for consumption and foods and beverages to be used as ingredients to prepare other foods and beverages.

Preferably, the level of acrylamide in the finished food product is reduced by at least about 10%, preferably at least about 30%, more preferably at least about 50%, still more preferably at least about 70%, and even more preferably at least about 90%.

B. Means of Practicing the Method

The present invention can be practiced by any suitable means. For example, the method herein can be practiced in batch, semi-batch, or continuous mode.

C. Food Products Having Reduced Levels of Acrylamide

Food products prepared according to the method herein can have a reduction in the acrylamide level of at least about 10%, preferably at least about 30%, more preferably at least about 50%, still more preferably at least about 70%, and even more preferably at least about 90%.

The method herein can be applied to the production of any suitable food product, including but not limited to carbohydrate-containing foods, especially low-moisture foods (e.g., less than about 10% moisture), that are heated during preparation. For instance, the method can be used to reduce the level of acrylamide found in potato chips, fabricated snack foods, French fries, breakfast cereals, breads, cookies, crackers, toaster pastries, pizza crust, pretzels, hash browns, tater tots, corn tortillas, and taco shells. In addition, the method herein can be used to reduce the level of acrylamide found in coffee and cocoa products.

In one embodiment, fried fabricated potato crisps have less than about 400 ppb acrylamide, preferably less than about 300 ppb, more preferably less than about 200 ppb, still more preferably less than about 50 ppb, and most preferably less than about 10 ppb.

In yet another embodiment, French fries made from cut potatoes have less than about 40 ppb acrylamide, preferably less than about 30 ppb, more preferably less than about 20 ppb, and most preferably less than about 10 ppb.

In still another embodiment, tortilla chips and corn chips have less than about 75 ppb acrylamide, preferably less than about 50 ppb, and more preferably less than about 10 ppb.

Although the method herein will generally be described in terms of preferred potato food products and tortilla chips, it should be understood by one skilled in the art that the method herein can be applied to any suitable food product. Non-limiting examples include crackers, breads (e.g., rye, wheat, oat, potato, white, whole grain products, mixed flours, loaves, twists, buns, rolls, pitas, matzos, focaccia, melba toast, zwieback, croutons, soft pretzels, soft and hard bread sticks, heat and serves), toaster pastries, cookies, danish, croissant, tarts, pie crusts, pastries, muffins, brownies, sheet cakes, donuts, snack foods (e.g., pretzels, tortilla chips, corn chips, potato chips, fabricated snacks, fabricated potato crisps, extruded snacks, extruded filled snacks, trail mix, granola, snack mixes, shoe-string potatoes), flours, corn meal, polenta, mixes (e.g., cake mixes, biscuit mixes, brownie mixes, bread mixes, pancake mixes, crepe mixes, batter mixes, pizza dough), refrigerated doughs (e.g., biscuits, breads, bread sticks, croissants, dinner rolls, pizza dough, cookies, danish, brownies, pie crust), frozen foods (e.g., pie crusts, pies, tarts, turnovers, pizzas, food pockets, cakes, French fries, hash browns, breaded products such as chicken and fish, breaded vegetables), bagels, breakfast cereals, biscuits, French fries, vegetables (e.g., dried, grilled, roasted, broiled, fried, vacuum dried), taco shells, hash browns, mashed potatoes, toast, grilled sandwiches, flour and corn tortillas, crepes, pancakes, waffles, batters, pizza crust, rice, herbs, spices, nuts, nut-based foods (e.g., peanut butter, foods containing chopped nuts), fruit (e.g., dried, grilled, roasted, broiled, fried, vacuum dried, baked, jellies, pie fillings, flambes, raisins), hush puppies, alcoholic beverages (e.g., beers and ales), products comprising roasted cocoa beans (e.g., cocoa, chocolates, confectionary coatings, hot chocolate, hot chocolate mixes, candy bars), coffee (e.g., roast and ground coffees, liquid concentrates, instant or powdered coffees, coffee beverages, coffee mixes) and animal foods (e.g., dog food, cat food, ferret food, guinea pig food, gerbil food, hamster food, bird food, llama food, ostrich food, emu food, cattle food, deer food, elk food, buffalo food, rabbit food, rat food, mouse food, chicken food, turkey food, pig food, horse food, goat food, sheep food, monkey food, fish food).

1. Dehydrated Potato Products

The present invention can be used to make dehydrated potato products having reduced levels of acrylamide. The following sets forth a method of making such dehydrated potato products, but the present invention is not limited to this particular embodiment. Although the embodiment set forth in detail below describes addition of multivalent cation before the cooked potatoes are comminuted, it should be understood that cation may be added at any suitable stage of any suitable process for making dehydrated potato products. For instance, the cation may be added to the potatoes before cooking, after cooking, before comminution, after comminution, or during any other suitable processing step before the final dehydrated potato product is formed. Furthermore, non-limiting examples of other embodiments may comprise: (a) adding cation to raw potato followed by conventional dehydrated potato processing, (b) adding cation to raw potato followed by shredding or thinly slicing and conventional processing, (c) adding cation to raw potato followed by shredding or thinly slicing, then blanching, then followed by conventional processing, (d) adding cation to blanched, shredded, or thinly sliced potato followed by conventional processing, or (e) any other suitable means of adding the multivalent cation. The method herein may also be practiced with any suitable method for making dehydrated potato products known in the art, such as those set forth in Potato Processing, 4^{th} Ed., Talburt and Smith, Eds., AVI Books, Van Nostrand Reinhold Co., New York, 1987, [hereinafter “Potato Processing”], at pp. 535-646.

In one preferred embodiment, dehydrated potato products, such as potato flakes, flanules, or granules, can be made in accordance with the following method. In general, the method comprises: (1) cooking potatoes to form cooked potatoes; (2) forming a wet mash from the cooked potatoes; (3) adding a multivalent cation to the wet mash; and (4) drying the wet mash to form dehydrated potato products.

In another embodiment, dehydrated potato products, such as potato flakes, flanules, or granules, can be made in accordance with the following method. In general, the method comprises: (1) cooking potatoes to form cooked potatoes; (2) adding a multivalent cation to the cooked potatoes; (3) forming a wet mash from the cooked potatoes; and (4) drying the wet mash to form dehydrated potato products.

Any suitable potatoes, such as those used to prepare conventional potato flakes, flanules, or granules, can be used to prepare the dehydrated potato products herein. Preferably, the dehydrated potato products are prepared from potatoes such as, but not limited, to Norchip, Norgold, Russet Burbank, Lady Rosetta, Norkotah, Sebago, Bintje, Aurora, Satuma, Kinnebec, Idaho Russet, Altura, Russet Norkotah, Atlantic, Shepody, Asterix, and Mentor.

Potatoes having less than about 5% reducing sugars (calculated on a dehydrated potato basis), preferably less than about 3%, and more preferably less than about 2%, are preferred. For example, potatoes having low levels of reducing sugars (i.e. <1.5%) are especially preferred for fried potato snacks.

The potatoes are subjected to cooking to soften them for mashing. The potatoes may be peeled, partially peeled, or unpeeled. The potatoes may be whole or may be sliced into pieces of any size before cooking. The cooking procedure can be any thermal or other type of cooking process that softens the potatoes for mashing. For instance, the potatoes may be cooked by submersion in water or steam.

For example, potato slices having an average thickness of about 3/8 inch (9.6 mm) to about 5/8 inch (16 mm) are typically cooked with steam having a temperature of from about 200° F. (93° C.) to about 250° F. (121° C.) from about 12 minutes (720 sec) to about 45 minutes (2700 sec), more particularly from about 14 minutes (840 sec) to about 18 minutes (1080 sec). Shoestring cut potatoes pieces are typically cooked with steam having a temperature of from about 200° F. (93° C.) to about 250° F. (121° C.) for about 7 minutes (420 sec) to about 18 minutes (1080 sec), more particularly from about 9 minutes (540 sec) to about 12 minutes (720 sec), to achieve the desired hardness.

Next, an effective amount of cation, preferably calcium, and more preferably calcium lactate, is added to the cooked potatoes. The cooked potatoes are then comminuted to produce a wet mash. Comminution of the cooked potatoes may be accomplished by any suitable means, such as but not limited to ricing, mashing, shredding, or a combination thereof.

Optional ingredients can be added and mixed into the wet mash. Such optional ingredients can include starch. Starch can include, but is not limited to, any suitable native or modified starch, including any dried potato products that are added into or back into the mash. Emulsifier can also optionally be added to the wet mash as a processing aid.

After the mash is formed, it can be further dried and processed as described below to form dehydrated potato products. Alternatively, the wet mash can be used to produce products such as, but not limited to, mashed potatoes, potato patties, potato pancakes, and potato snacks such as extruded French fries, potato sticks, and snack chips.

For example, the wet potato mash can be used to produce extruded French fried potato products such as those described in U.S. Pat. No. 3,085,020, issued Apr. 9, 1963 to Backinger et al.

After forming the mash, the mash is dried to form dehydrated potato products. These dehydrated potato products can be in any form, such as but not limited to flakes, flanules, granules, agglomerates, sheets, pieces, bits, flour, or particulates.

Any suitable procedure, such as those known in the art, for producing such dehydrated potato products from a mash may be employed, and any suitable equipment may be used. For example, the mash can be dried to produce flakes according to known processes such as those described in U.S. Pat. No. 6,066,353, issued May 23, 2000 to Villagran, et al., as well as those processes described in U.S. Pat. No. 2,759,832 issued Aug. 19, 1956 to Cording et al., and U.S. Pat. No. 2,780,552 issued Feb. 5, 1957 to Willard et al. The mash can be dried to make flanules according to the process set forth in U.S. Pat. No. 6,287,622, issued Sep. 11, 2001 to Villagran et al. Granules can be produced by processing the mash according to the process described in U.S. Pat. No. 3,917,866, issued Nov. 4, 1975 to Purves et al., or by other known processes such as that described in U.S. Pat. No. 2,490,431 issued Dec. 6, 1949 to Greene et al. Suitable dryers can be selected from those well known drying devices including but not limited to fluidized bed dryers, scraped wall heat exchangers, drum dryers, freeze-dryers, air lift dryers, and the like.

Preferred drying methods include those that reduce the amount of total thermal input. For example, freeze drying, drum drying, resonant or pulse flow drying, infrared drying, or a combination thereof is preferred when producing flakes; and air lift drying, fluidized bed drying, or a combination thereof is preferred when producing granules.

Although the dehydrated potato products herein will be primarily described in terms of flakes, it should be readily apparent to one skilled in the art that the potato mash of the present invention can be dehydrated to produce any desired dehydrated potato product that can be derived from a mash.

Drum drying, such as with drum dryers commonly used in the potato product industry, is the preferred method for drying the potato mash to form flakes. The preferred process utilizes a single drum drier wherein the wet potato mash is spread onto the drum in a thin sheet having a thickness of from about 0.005 inch (0.127 mm) to about 0.1 inch (2.54 mm), preferably from about 0.005 inch (0.127 mm) to about 0.05 inch (1.27 mm), more preferably about 0.01 inch (0.254 mm). Typically, when a drum dryer is used, the mash is fed to the top surface of the drum by a conveying means. Small diameter unheated rolls progressively apply fresh potato mash to portions already on the drum, thus building up a sheet, or layer, having a predetermined thickness. The peripheral speed of the small rolls is the same as that of the drum. After the layer of mash travels around a portion of the circumference of the drum, a doctor knife removes the dried sheet by peeling the dried sheet away from the drum. Typically, the drum dryer itself is heated to temperatures in a range of from about 250° F. (121° C.) to about 375° F. (191° C.), preferably from about 310° F. (154° C.) to about 350° F. (177° C.), and more preferably from about 320° F. (160° C.) to about 333° F. (167° C.) by pressurized steam contained within the drum at pressures of from about 70 psig (480 kPa) to about 140 psig (970 kPa). For best results, the rotational speed of the dryer drum and the internal temperature thereof are suitably controlled so as to give a final product having a moisture content of from about 5% to about 14%, preferably from about 5% to about 12%. Typically, a rotational speed of from about 9 sec/rev to about 25 sec/rev, preferably about 11 sec/rev to about 20 sec/rev, is sufficient.

Once the wet mash is sheeted and dried, the resulting dried sheet of flakes can then be broken into smaller sections if desired. These smaller sections can be of any desired size. Any method of breaking the sheet that minimizes starch and potato cell damage, such as fracturing, grinding, breaking, cutting, or pulverizing, can be used. For example, the sheet can be comminuted with an Urschel Comitrol™, manufactured by Urschel Laboratories, Inc. of Valparaiso, Ind., to break up the sheet. Alternatively, the sheet of flakes can be left intact. As used herein, both the intact sheet of flakes and smaller sheet sections are included in the term “potato flakes.”

2. Foods Made from Dehydrated Potato Products

The multivalent cation-treated dehydrated potato products can be used to make any suitable food product. An especially preferred use of the dehydrated potato products is in the production of fabricated snacks made from a dough, preferably fabricated chips. Examples of such fabricated chips include those described in U.S. Pat. No. 3,998,975 issued Dec. 21, 1976 to Liepa, U.S. Pat. No. 5,464,642 issued Nov. 7, 1995 to Villagran et al., U.S. Pat. No. 5,464,643 issued Nov. 7, 1995 to Lodge, and WO 96/01572 published Jan. 25, 1996 by Dawes et al.

The dehydrated potato products can also be rehydrated and used to produce food products such as mashed potatoes, potato patties, potato pancakes, and other potato snacks such as extruded French fries and potato sticks. For example, dehydrated potato products can be used to produce extruded French fried potato products such as those described in U.S. Pat. No. 3,085,020, issued Apr. 9, 1963 to Backinger et al., and U.S. Pat. No. 3,987,210, issued Oct. 18, 1976 to Cremer. The dehydrated potato products can also be used in breads, gravies, sauces, baby food, or any other suitable food product.

3. Foods Made from Doughs

In another embodiment, multivalent cation can be added to a dough and/or to one or more ingredients used to make a dough. As used herein, “adding” a multivalent cation to a dough includes adding a multivalent cation to the dough itself and/or to one or more dough ingredients. These doughs can comprise any starchy products such as, but not limited to, wheat, corn, rye, rice, potato, barley, sorghum, and mixtures thereof. Such doughs can be used to make product such as, but not limited to, breads, pastries, pizza crusts, crisp breads, fabricated snacks, breakfast cereals, muffins, donuts, cookies, crackers, egg roll wrappers, tortillas, and pie crusts.

In a particular embodiment, a fabricated snack is made from a dough. In this embodiment, the method comprises:
(1) adding a multivalent cation to a dough;
(2) forming a snack piece from the dough; and
(3) cooking the snack piece to form a fabricated snack.
   Cooking can be performed by any suitable method, for instance by frying, baking, or a combination of frying or baking. Furthermore, the forming and cooking steps can be carried out simultaneously, such as with extruded snack products.

In another embodiment, the fabricated snack is made by the method comprising:
(1) blending dry ingredients;
(2) optionally adding emulsifier to dry ingredients;
(3) adding water;
(4) mixing to form a dough;
(5) forming a dough sheet;
(6) forming a snack piece from the dough sheet; and
(7) cooking the snack piece to form a fabricated snack.
   Multivalent cation can be added at any suitable stage of the process (e.g., before, during or after any of steps 1-7). For instance, the cation may be added during the blending, optionally adding emulsifier, adding water, mixing, and/or forming steps. Alternatively, the cation can be applied, preferably as a solution, to the dough surface; this can occur either before or after the snack pieces are formed from the dough sheet. In one embodiment, the cation solution is added to the surface of the dough sheet.

4. Potato Chips

The present invention can be used to make potato chips having reduced levels of acrylamide. The following sets forth a preferred method of making such potato chip products, but the present invention is not limited to this particular embodiment. For example, multivalent cation may be added at any suitable processing stage of art-recognized potato-chipping methods, such as those set forth in Potato Processing, at pp. 371-489.

In a preferred embodiment, the present invention provides a method for reducing the level of acrylamide in potato chips, comprising:
(1) optionally peeling potatoes;
(2) optionally washing potatoes;
(3) slicing potatoes to form potato slices;
(4) optionally rinsing the potato slices;
(5) optionally blanching the potato slices;
(6) optionally cooling the potato slices;
(7) adding a multivalent cation to the potato slices;
(8) optionally drying the potato slices;
(9) frying the potato slices to form potato chips.

Although the foregoing describes addition of cation at step (7) above, it should be understood that the cation may be added at any suitable stage of the process instead or in addition to step (7) (e.g., before, during or after any of steps 1-6 or 8-9). For instance, the cation may be added to the potatoes before slicing, after slicing, after rinsing, during blanching, during cooling, or at any other suitable stage before drying, if the optional drying step is performed, or at any other suitable stage before frying if the potato slices are not optionally dried.

In another embodiment, potato slice blanching and soaking solutions are pumped through a column comprising a cationic ion exchange resin, wherein the cation comprises a multivalent cation. The effluent from the column is returned to the potato slices. The potato slices are then processed according to typical processing procedures. Practicing the method in this manner can return at least part of the native potato flavors back to the chip that may be lost during the blanching and treatment steps.

Potato chips made according to the method herein can have less than about 150 ppb acrylamide, preferably less than about 100 ppb, more preferably less than about 50 ppb, even more preferably less than about 10 ppb, and most preferably less than about 5 ppb.

5. French Fries

The present invention can be used to make French fries having reduced levels of acrylamide. The following sets forth a preferred method of making such French fries, but the present invention is not limited to this particular embodiment. For example, cation may be added at any suitable processing stage of art-recognized methods for making French fries, such as those set forth in Potato Processing, at pp. 491-534, or those methods described in U.S. Pat. Nos. 6,001,411 and 6,013,296.

In a preferred embodiment, the present invention provides a method for reducing the level of acrylamide in French fries, comprising:
(1) optionally peeling potatoes;
(2) optionally washing potatoes;
(3) cutting potatoes to form potato strips;
(4) optionally rinsing the potato strips;
(5) optionally blanching the potato strips;
(6) optionally cooling the potato strips;
(7) adding a multivalent cation to the potato strips;
(8) optionally drying the potato strips;
(9) optionally coating the potato strips; and
(10) par-frying the potato strips to form par-fries.

The par-fries can then be frozen, packaged, and stored for later frying to form the final French fries.

Although the foregoing describes addition of the cation at step (7) above, it should be understood that cation may be added at any other suitable stage of the process instead or in addition to step (7) (e.g., before, during or after any of steps 1-6 or 8-10). For instance, the cation may be added to the potatoes before cutting, after cutting, after rinsing, during blanching, during cooling, or at any other suitable stage before drying, if the optional drying step is performed, or at any other suitable stage before par-frying if the potato strips are not optionally dried. Although less preferred, cation may be added between the steps of par-frying and final frying to form the final French fries.

Most preferably, the potato strips are blanched before the cation is added. If coated French fries are desired, a suitable coating material, such as starch or a blend of materials comprising one or more starches, can be used to coat the potato strips before par-frying.

Finished French fries made from the par-fries of the present invention can have less than about 40 ppb acrylamide, preferably less than about 30 ppb, more preferably less than about 20 ppb, and most preferably less than about 10 ppb.

6. Tortilla Chips

Tortilla chips are particularly popular consumer snack products. Tortilla chips are traditionally made from whole kernel corn that has been cooked in a hot lime solution for about 5 to about 50 minutes, then steeped overnight. The cooking-steeping process softens the outer hull and partially gelatinizes the starch in the endospenn of the corn. This cooked-steeped corn, called “nixtamal,” is then washed to remove the outer hull and ground to form a plastic dough, known as “masa,” that contains about 50% moisture. The freshly-ground masa is sheeted, cut into snack pieces, and baked for about 15 seconds to about 30 seconds at a temperature of from about 575° F. (302° C.) to about 600° F. (316° C.) to reduce the moisture content to from about 20% to about 35%. The baked snack pieces are then fried in hot oil to form tortilla chips having a moisture content of less than about 3%. See, e.g., U.S. Pat. No. 2,905,559, issued Nov. 1, 1958 to Anderson et al., U.S. Pat. No. 3,690,895, issued Sep. 12, 1972 to Amadon et al., and Corn: Chemistry and Technology, American Association of Cereal Chemists, Stanley A. Watson, et. al., Ed., pp. 410-420 (1987).

Tortilla chips can also be made from dried masa flour. In typical processes for making such dried masa flour, such as those described in U.S. Pat. No. 2,704,257 issued Mar. 1, 1955, to de Sollano et al., and U.S. Pat. No. 3,369,908, issued Feb. 20, 1968 to Gonzales et al., the lime-treated corn is ground and dehydrated to a stable form. The dried masa flour can be later rehydrated with water to form a masa dough that is then used to produce tortilla chips, such as those described in U.S. Pat. No. 6,572,910, issued Jun. 3, 2003, to Lanner et al.

In one embodiment, a tortilla chip made from masa is made by the method comprising:
(1) adding a multivalent cation to a dough comprising masa;
(2) forming a snack piece from the dough; and
(3) cooking the snack piece to form a tortilla chip.

In another embodiment, a tortilla chip made from nixtamal is made by the method comprising:
(1) adding a multivalent cation to nixtamal;
(2) forming a snack piece from the nixtamal; and
(3) cooking the snack piece to form a tortilla chip.
   Multivalent cation can be added at any suitable stage of the process. In one embodiment, a cation solution is added to the surface of the dough sheet.

Cooking can be performed by any suitable method, for instance by frying, baking, or a combination of frying or baking. Furthermore, the forming and cooking steps can be carried out simultaneously, such as by extrusion.

In one embodiment, the tortilla chips have less than about 75 ppb acrylamide, preferably less than about 50 ppb, and more preferably iess than about 10 ppb.

D. Article of Commerce

Another embodiment of the invention is an article of commerce comprising:
(a) a food product, wherein said food product has a reduced level of acrylamide;
(b) a container for containing the food product; and
(c) a message associated with the container.

The message informs the consumer that the food product contains a reduced level of acrylamide. Suitable messages include, but are not limited to, messages that communicate “reduced” or “low” levels of acrylamide, messages that communicate that less than a specified amount of acrylamide is present (e.g., less than 5 ppb), and messages that communicate that the food product meets or exceeds a suggested or mandatory level (e.g., regulatory threshold or signal level).

The message can be printed material attached directly or indirectly to the container, attached directly or indirectly near the container, or alternatively can be a printed, electronic, or broadcast message associated with the container.

Any container from which the food product can be dispensed, presented, displayed, or stored is suitable. Suitable containers include, but are not limited to, bags, canisters, boxes, bowls, plates, tubs, and cans.

### Analytical Methods

Parameters used to characterize elements of the present invention are quantified by particular analytical methods. These methods are described in detail as follows.

1. Acrylamide

### Method for Measuring Acrylamide (AA) in Food Products

Summary

Food products are spiked with 1-¹³C-acrylamide (¹³C-AA) and extracted with hot water. The aqueous supernatant is extracted three times with ethyl acetate, and the ethyl acetate extracts are combined and concentrated and analyzed by LC/MS with selected ion monitoring for specific detection of AA and ¹³C-AA.

### Extraction of Sample

1. Weigh 6.00±0.01 g of sample into a 125-mL Erlenmeyer flask. Note: Place the sample into a food processor and pulse for 30 seconds so that the particle size is about 1/8 inch or less. If the sample is too small to be effectively ground in a food processor, place the sample in a new plastic bag (e.g., Whirl-Pak™ or equivalent) and pulverize with a rubber mallet until the particle size is 1/8 inch or less.
2. Add 120 μL of 100 ng/μL ¹³C-AA in de-ionized distilled water (ISTD 2), with an adjustable 1000-μL pipette (calibrated), directly onto the sample.
3. Using a dispenser, add 40 mL of de-ionized distilled water to the flask and cover with foil.
4. Place into a 65° C. water bath for 30 min.
5. With a dispenser, add 10 mL of ethylene dichloride to the flask, and homogenize with a Tekmar Tissumizer™ (SDT-1810) or Ultra-Turrax® (T18 Basic) for 30 seconds, or until uniform. Rinse the probe into the flask with deionized distilled water.
6. Place 25 g of the homogenate into an 8-dram vial
7. Tightly cap the tube and centrifuge for 30 minutes at 2500-5200 RPM.
8. Transfer 8 g of supernatant to another 8-dram vial being careful to avoid solid particles.
9. Add 10 mL of ethyl acetate with a dispenser, cap, and vortex for 10 seconds.
10. Allow any emulsion to break up; help by swirling or shaking once or twice and then allowing layers to split.
11. Transfer as much of the top layer (ethyl acetate) as possible to a scintillation vial, without transferring any liquid (water) from the interface. Extract twice more with 5-mL portions of ethyl acetate and add to the same scintillation vial. Then, add approximately 2 g of anhydrous sodium sulfate.
12. Concentrate the extract with a gentle stream of nitrogen in a 60-65° C. water bath to about 1 mL. Transfer the extract to a Pierce REACTI-VIAL™ or equivalent conical-shaped glass vial and further concentrate the extract to a final volume of approximately 100-200 μL. Place this extract into an autosampler vial with a conical sleeve.
   Preparation of Standards

Stock Solutions and Internal Standards

| | | Volumetric | | Concentration |
|---|---|---|---|---|
| Solution | Weight | Flask | Solvent | (ppm) |
| Stock 1 | 0.1000 g | 100-mL | Ethyl | 1000 |
| | Acrylamide | | Acetate | |
| | (AA) | | | |
| ISTD 1 | 0.0100 g | 100-mL | Ethyl | 100 |
| | ¹³C-Acrylamide | | Acetate | |
| Stock 2 | 0.1000 g | 100-mL | Deionized | 1000 |
| | Acrylamide | | Distilled | |
| | (AA) | | Water | |
| ISTD 2 | 0.0100 g | 100-mL | Deionized | 100 |
| | ¹³C-Acrylamide | | Distilled | |
| | | | Water | |

Intermediate Standards

| | Volume | Volumetric | | |
|---|---|---|---|---|
| | Stock 1 AA | Flask | | Concentration |
| Solution | (μL) | (mL) | Solvent | (ppm) |
| INT 1 | 100 | 10 | Ethyl Acetate | 10 |
| INT 2 | 1000 | 10 | Ethyl Acetate | 100 |

Calibration Standards

| | Volume | Volume | Volume | Volumetric | | Conc. | Conc. |
|---|---|---|---|---|---|---|---|
| | INT 1 | INT 2 | ISTD 1 | Flask | | AA | ISTD 1 |
| Standard | (μL) | (μL) | (μL) | (mL) | Solvent | (ppm) | (ppm) |
| 0 | 0 | 0 | 450 | 10 | Ethyl Acetate | 0 | 4.50 |
| 0.25 | 250 | 0 | 450 | 10 | Ethyl Acetate | 0.250 | 4.50 |
| 0.75 | 750 | 0 | 450 | 10 | Ethyl Acetate | 0.750 | 4.50 |
| 1.5 | 0 | 150 | 450 | 10 | Ethyl Acetate | 1.50 | 4.50 |
| 3.0 | 0 | 300 | 450 | 10 | Ethyl Acetate | 3.00 | 4.50 |
| 5.0 | 0 | 500 | 450 | 10 | Ethyl Acetate | 5.00 | 4.50 |

Homogenizer Cleaning Procedure

Use this cleaning procedure between every sample.
1. Fill a 1-L Erlenmeyer flask with hot tap water (=80% full) and add a drop of Dawn™ dishwashing liquid (available from the Procter & Gamble Co.) or equivalent.
2. Insert the dispersing element probe into the water as far as possible.
3. Homogenize the solution for about 10-15 seconds.
4. Empty the cleaning solution from the Erlenmeyer; rinse and refill the flask with hot tap water.
5. Homogenize again for about 10-15 seconds.
6. Empty the flask and refill with hot tap water; homogenize again for about 10-15 seconds
7. If the water is not clear and free of particulates, continue homogenizing clean hot tap water as many times as necessary to achieve this condition.
8. When the hot tap water is clear and free of particulates, rinse the probe with deionized distilled water.

### Analysis by LC/MS

Samples are analyzed using a Waters 2690 LC interfaced to a Micromass LCZ mass spectrometer.

| | |
|---|---|
| Mobile Phase | 100% H₂O, 10 mM NH₄Ac, adjusted to pH |
| | 4.6 w/formic acid |
| Column | 2.0 mm × 150 mm, YMC C18 AQ (available |
| | from Waters Corp.) |
| Flow rate | 0.2 mL/min |
| Interface | Direct (no split) |
| Injection | 5 μL |
| volume | |
| MS ionization | Electrospray, positive ion mode |
| mode | |
| MS detection | Selected ion monitoring: m/z 72 (AA), |
| mode | m/z 73 (¹³C-AA); dwell times: 0.5 s |

### Data Analysis

Response ratios (area of AA peak/area of ¹³C-AA peak) are plotted against the corresponding concentration ratios for a series of five standards in ethyl acetate. All standards contain 4.5 μg/mL ¹³C-AA, and AA concentrations ranging from 0 to 5 μg/mL. Linear regression results in a calibration curve from which concentration ratios in extracts are determined from measured response ratios. When this concentration ratio is multiplied by the accurately known ¹³C-AA level (nominally 2 ppm) added to sample in step two of the extraction procedure, the level of AA in ppm results.

Sample Calculation for LC/MS:

The calibration curve is generated by plotting the response ratio (area m/z 72/area m/z 73) on the y axis vs. the concentration ratio ([AA]/[13C-AA]) on the x-axis. For this example, the equation of that line is y=0.899x+0.0123.
Measured area of AA peak (m/z 72) at 4.0 min: 100,000
Measured area of 13C-AA peak (m/z 73) at 4.0 min: 500,000
Respense ratio Rᵣ=0.200. From the slope and intercept of the calibration curve, the concentration ratio R_{c} is calculated: R_{c}=(0.200-0.0123)/0.899=0.209
Given the spike level of 13C-AA in the sample (2 ppm), the measured level of AA is 0.209×2 ppm=0.418 ppm
   Quality Assurance/Quality Control (QA/QC)
   1. All balances used in the preparation of standards and/or samples, must have their calibrations checked weekly with a set of qualified weights. The balances should be checked with at least three weights covering the range of sample/standard weights to be measured.
   2. A six-point calibration curve should be performed daily.
   3. A working reference material (WRM) should be analyzed with each set of samples. The concentration of this material should be within 2σ of the running mean. If it is not, the instrument should be recalibrated and the WRM recalculated.
      2. % Reduction of Acrylamide
      % Reduction Acrylamide=[(Acrylamide level in control sample−Acrylamide level in cation-treated sample)/Acrylamide level in control sample]×100.

The control sample is prepared in exactly the same manner as the cation-treated sample, with the exception that cation is not added.

### EXAMPLES

The following examples are illustrative of the present invention but are not meant to be limiting thereof.

### EXAMPLE 1

### Dehydrated Potato Product

Russett Burbank potatoes are steamed for about 26 minutes (1560 sec), then drained and mashed. 800 g of the mashed potato is set aside to be used as a standard. To a second 800 g of mashed potato, about 0.34 g calcium chloride dihydrate is added and mixed. Both 800 g samples are spread out on a cookie sheet, and are placed in an oven (Yamato®, nodel number DKN400) at 55° C. for about 8 hours (28,800 sec). The final material contains about 5% moisture. Both samples are ground separately in a pulverizer to produce a coarse powder. About 100 g of each sample is collected and set aside for later use as an ingredient. The sample treated with calcium chloride dihydrate contains a reduced level of acrylamide.

### EXAMPLE 2

### Potato Crisps

Materials

| | | |
|---|---|---|
| Potato starch | 8.0 | g |
| Potato flakes | 93.8 | g |
| Water | 50.0 | g |
| Emulsifier | 1.0 | g |

(Note: the emulsifier is a mixture of mono-, di- and triglycerides)

Equipment
Food processor (Cuisinart®)
Pasta sheeter (made by Mercado® of Italy)
Dough oval cutter and cutting board
Fryer (Cecilwareg Deep Fat Fryer model EL 120)
   Procedure
1. 200 ml beaker is placed on an electronic balance and tared.
2. The dry materials are weighed out (+0.02 g) in the 200 ml beaker.
3. The dry ingredients are added to the food processor vessel. The dry ingredients are then mixed for about 30 seconds.
4. 1.0 g of emulsifier is placed in a 100 ml beaker. 50 g water is added, and heated for about 20 seconds in a microwave oven.
5. The water is mixed with the emulsifier in the beaker with a homogenizer for approximately 5 seconds.
6. 43.5 g of the water-emulsifier mixture is added to the dry ingredients in the food processor vessel.
7. The food processor is turned on, and after about 30 seconds, it is stopped, opened, and scraped along the sides and bottom with a spatula.
8. The top is placed back on and run for about another 30 seconds (about 60 seconds total mix time).
9. The top cover of the food processor is then taken off, and the dough is placed into a feeder for the pasta sheeter. The pasta sheeter rolls are set at the narrowest possible setting.
10. The sheet is run through the pasta sheeter about 5 times, or until the sheet is about 0.5 mm thick.
11. Dough ovals are cut out from the dough sheet with the oval cutter on the cutting board.
12. The dough ovals are fried in vegetable oil for about 18 seconds in vegetable oil at about 190° C.
13. The fried ovals are placed on a plate with paper towels for about 5 minutes (300 sec), and then are placed in a placed bag for analysis.
   Two sets of fried potato crisps are made. One set is made using the untreated potato flakes of Example 1. The second set is made with the calcium-treated potato flakes of Example 1. The samples and the controls are analyzed for acrylamide using the method set forth herein. The acrylamide level in the calcium-treated chips is significantly lower than the acrylamide level in the control (untreated chips). The untreated chips have an acrylamide level of about 5,683 ppb, whereas the treated chips have an acrylamide level of about 2,564 ppb. (The moisture content of the crisps is about 2.5% by weight.)

### EXAMPLE 3

### Potato Crisps

The crisp-making procedure of Example 2 is used, except that untreated, commercially available potato flakes are used instead of laboratory-prepared, treated flakes, and the fry time is about 8 seconds. Two sets of potato crisps are prepared by this procedure using the commercial potato flakes. The first is a control sample made according to the steps set forth in Example 2. The second sample is prepared in the same manner except that 0.5 g of calcium chloride dihydrate crystals are added to the water before mixing it with the dry ingredients. The samples and the controls are analyzed for acrylamide using the method set forth herein. The acrylamide level in the calcium-treated chips is significantly lower than the acrylamide level in the control (untreated chips). The untreated chips have an acrylamide level of 750 ppb, whereas the treated chips have an acrylamide level of about 112 ppb. (The moisture content of the crisps is about 2.8% by weight.)

### EXAMPLE 4

### Potato Chips

Potato chips having reduced levels of acrylamide are made using raw potato slices. Russet Burbank potatoes are peeled and sliced to ˜1.1 mm thickness, then rinsed and patted dry. The potato slices are blanched in about 165° F. water for about 15 seconds, then cooled and drained. About 100 grams of blanched slices are then soaked in about 250 ml of 3% by weight calcium chloride solution in water, for about 60 seconds. The treated potato slices are then fried in vegetable oil in a fryer set at 180° C. for about 180 seconds. Control samples are prepared in the same manner as the sample above, with the exception that the calcium chloride is not added to the soaking solution.

The samples and the controls are analyzed for acrylamide using the method set forth herein. The acrylamide level in the calcium-treated chips is significantly lower than the acrylamide level in the control (untreated chips). The control sample contains about 4,392 ppb acrylamide, whereas the treated sample has about 3,378 ppb. (The moisture level of the chips is about 2%.)

### EXAMPLE 5

### Potato Crisps

Potato crisps are prepared as in Example 3, except that instead of 0.5 g of calcium chloride dihydrate crystals, 0.25 g of magnesium chloride hexahydrate salt is added to the water before mixing it with the dry ingredients for making the treated sample; furthermore, the crisps of this example are fried for about 16 seconds. The samples and the controls are analyzed for acrylamide using the method set forth herein. The acrylamide level in the magnesium-treated chips is significantly lower than the acrylamide level in the control (untreated chips). The untreated chips have an acrylamide level of 3,548 ppb, whereas the treated chips have an acrylamide level of about 1,599 ppb. (The moisture content of the crisps is about 2.5% by weight.)

### EXAMPLE 6

### Potato Crisps

Potato crisps are prepared as in Example 3, except that instead of 0.5 g of calcium chloride dihydrate crystals, 0.25 g of zinc chloride salt is added to the water before mixing it with the dry ingredients for making the treated sample; furthermore, the crisps of this example are fried for about 16 seconds. The samples and the controls are analyzed for acrylamide using the method set forth herein. The acrylamide level in the zinc-treated chips is significantly lower than the acrylamide level in the control (untreated chips). The untreated chips have an acrylamide level of 3,964 ppb, whereas the treated chips have an acrylamide level of about 843 ppb. (The moisture content of the crisps is about 2.5% by weight.)

### EXAMPLE 7

### Potato Crisps

This example demonstrates the efficacy of adding the multivalent cation in its water soluble form, versus an insoluble form. The crisp-making procedure of Example 2 is used, except that untreated, commercially available potato flakes are used instead of laboratory-prepared, treated flakes, and the fry time is about 12 seconds. Three sets of potato crisps are prepared by this procedure using the commercial potato flakes. The first is a control sample made according to the steps set forth in Example 2. The second sample is prepared in the same manner except that 0.5 g of calcium chloride dihydrate crystals are added to the water before mixing it with the dry ingredients. The third sample is prepared in the same manner except that 0.5 g of calcium carbonate is added to the water before mixing it with the dry ingredients (calcium carbonate has low solubility in water). The samples are analyzed for acrylamide using the method set forth herein. The acrylamide levels of the three sets of crisps is shown in the table below. (The moisture content of the crisps is about 3% by weight.)

| Sample | Acrylamide Level (ppb) |
|---|---|
| 1 (Control) | 747 |
| 2 (Calcium chloride treated) | 355 |
| 3 (Calcium carbonate treated) | 735 |

### EXAMPLE 8

### Article of Commerce

The treated potato crisps of Example 3 are packaged in a bag for sale to consumers. Printed on the bag is a message stating, “Low in acrylamide!”

### EXAMPLE 9

### Article of Commerce

The treated potato chips of Example 4 are packaged in a bag for sale to consumers. A television commercial for the chips communicates the message, “Our chips are lower in acrylamide!”

### EXAMPLE 10

### Rice Crisps

Pre-gelled rice starch in this example is used since it contains no significant asparagine or reducing sugar. This example shows that without asparagine and reducing sugar, little acrylamide will form in the crisps during frying.

Materials

| | | |
|---|---|---|
| Pre-gelled rice starch | 100.0 | g |
| Water | 43 | g |
| Emulsifier | 1.1 | g |

(Note: the emulsifier is a mixture of mono-, di- and triglycerides)

Equipment
Food Processor (Cuisinart®)
Pasta sheeter (made by Mercado® of Italy)
Dough oval cutter and cutting board
Fryer (Cecilware® Deep Fat Fryer model EL 120).
   Procedure
1. A 250 ml beaker is placed on an electronic balance and tared.
2. The rice starch is weighed out in the 250 ml beaker.
3. The rice starch is added to the food processor vessel.
4. About 1.1 g of emulsifier is placed in a 100 ml beaker. About 43 g water is added, and heated for about 20 seconds in a microwave oven.
5. The water is mixed with the emulsifier in the beaker with a homogenizer for approximately 5 seconds.
6. The water-emulsifier mixture is added to the dry ingredients in the food processor vessel.
7. The food processor is turned on, and after about 30 seconds, it is stopped, opened, and scraped along the sides and bottom with a spatula.
8. The top is placed back on and the food processor is run for about another 30 seconds (about 60 seconds total mix time).
9. The top cover of the food processor is taken off, and the dough is placed into a feeder for the pasta sheeter. The pasta sheeter rolls are set at the narrowest possible setting.
10. The sheet is run through the pasta sheeter about 5 times, or until the sheet is about 0.5 mm thick.
11. Dough ovals are cut out from the dough sheet with the oval cutter on the cutting board.
12. The dough ovals are fried in vegetable oil for about 14 seconds in vegetable oil at about 190° C.
13. The fried ovals are placed on a plate with paper towels for about 5 minutes, and then are placed in a plastic bag for analysis.
   Analysis of these rice crisps indicates no detectable acrylamide. The moisture level of the crisps is about 2%.

### EXAMPLE 11

### Rice Crisps

Known amounts of asparagine and dextrose are added to a rice starch crisp formulation in order to promote the formation of acrylamide during frying. In these examples, about 1 gram of asparagine and 2 grams of dextrose are added to the formulation per 100 grams of rice starch.

Materials

| | | |
|---|---|---|
| Pre-gelled rice starch | 100.0 | g |
| 20% dextrose solution | 10.0 | g |
| 3% asparagine solution | 33.0 | g |
| Water | 3.0 | g |
| Emulsifier | 1.1 | g |

(Note: the emulsifier is a mixture of mono-, di- and triglycerides)

Equipment
Food processor (Cuisinart®)
Pasta sheeter (made by Mercado® of Italy)
Dough oval cutter and cutting board
Fryer (Cecilware® Deep Fat Fryer model EL 120).
   a. Rice Starch Control
   Procedure
1. A 250 ml beaker is placed on an electronic balance and tared.
2. The rice starch is weighed out in the 250 ml beaker.
3. The rice starch is added to the food processor vessel.
4. About 10.0 g of 20% dextrose solution, about 33.0 g of 3% asparagine solution, about 3.0 g of water, and about 1.1 g of emulsifier are added to a beaker and heated for about 20 seconds in a microwave oven.
5. The mixture in the beaker is mixed with a homogenizer for approximately 5 seconds.
6. The emulsified mixture is added to the dry ingredients in the food processor vessel.
7. The food processor is turned on, and after about 30 seconds, it is stopped, opened, and scraped along the sides and bottom with a spatula.
8. The top is placed back on and run for about another 30 seconds (about 60 seconds total mix time).
9. The top cover of the food processor is taken off, and the dough is placed into a feeder for the pasta sheeter. The pasta sheeter rolls are set at the narrowest possible setting.
10. The sheet is run through the pasta sheeter about 5 times, or until the sheet is about 0.5 mm thick.
11. Dough ovals are cut out from the dough sheet with the oval cutter on the cutting board.
12. The dough ovals are fried in vegetable oil for about 14 seconds in vegetable oil at about 190° C.
13. The fried ovals are placed on a plate with paper towels for about 5 minutes, and then are placed in a plastic bag for analysis.
14. The samples are analyzed for % moisture and acrylamide. The moisture is about 2%. The results of the acrylamide analysis are shown in the table below.
   b. Rice Starch Crisps Treated with Calcium Chloride

The procedure of part (a) is used except that 0.5 grams of calcium chloride dihydrate is added to the mixture of dextrose solution, asparagine solution, water, and emulsifier prior to homogenization. The samples are analyzed for % moisture and acrylamide. The moisture is about 2%. The results of the acrylamide analysis are shown in the table below.

c. Rice Starch Crisps Treated with Zinc Chloride

The procedure of part (a) is used except that 0.5 grams of anhydrous zinc chloride is added to the mixture of dextrose solution, asparagine solution, water, and emulsifier prior to homogenization. The samples are analyzed for % moisture and acrylamide. The moisture is about 2%. The results of the acrylamide analysis are shown in the table below.

d. Rice Starch Crisps Treated with Zinc Chloride

The procedure of part (a) is used except that 0.1 grams of anhydrous zinc chloride is added to the mixture of dextrose solution, asparagine solution, water, and emulsifier prior to homogenization. The samples are analyzed for % moisture and acrylamide. The moisture was about 2% The results of the acrylamide analysis are shown in the table below.

Results of experiments (a) through (d)

| | | Acrylamide |
|---|---|---|
| | | in the fried |
| Experiment | Description | crisps (ppb) |
| (a) | Control - Rice starch crisp | 3274 |
| | with 1% asparagine and 2% | |
| | dextrose added to the dough | |
| (b) | 0.5 g calcium chloride | 183 |
| | dehydrate added | |
| (c) | 0.5 g zinc chloride added | 15 |
| (d) | 0.1 g zinc chloride added | 651 |

### EXAMPLE 12

### Potato Crisps

This example shows the ability of multivalent cations to reduce acrylamide formation in a formulated chip. Potato flakes typically comprise about 1% asparagine and about 2% reducing sugar. The same lots of all raw materials are used for each experiment in this example.

Materials

| | | |
|---|---|---|
| Potato starch | 8.0 | g |
| Potato flakes | 93.8 | g |
| Water | 50.0 | g |
| Emulsifier | 0.8 | g |

(Note: the emulsifier is a mixture of mono-, di- and triglycerides)

Equipment
Food processor (Cuisinart®)
Pasta sheeter (made by Somerset Industries® Model CDR-1550)
Dough oval cutter and cutting board
Fryer (Cecilware® Deep Fat Fryer model EL 120).
   a. Potato Crisp Control

### Procedure

1. A 250 nil beaker is placed on an electronic balance and tared.
2. The dry materials are weighed out (+0.02 g) in the 250 ml beaker.
3. The dry ingredients are added to the food processor vessel. The ingredients are then mixed in the food processor for about 30 seconds.
4. About 0.8 g of emulsifier is added a 100 ml beaker. About 50 g water is added to the beaker, then the mixture is heated about 20 seconds in the microwave oven, or until
5. The water-emulsifier mixture in the beaker is blended with a homogenizer for approximately 5 seconds.
6. The water-emulsifier mixture is added to the food processor vessel.
7. The food processor is started. After about 30 seconds, the food processor is stopped, the vessel is opened and the sides and bottom are scraped with a spatula.
8. The top of the vessel is placed back on and the food processor is run for about another 30 seconds (about 60 second total mix time).
9. The top cover of the food processor is taken off, and the dough is placed into a feeder for the pasta sheeter. The pasta sheeter rolls are set at the narrowest possible setting.
10. The sheet is run through the pasta sheeter about 5 times, or until the sheet is about 0.5 mm thick.
11. Dough ovals are cut out from the dough sheet with the oval cutter on the cutting board.
12. The dough ovals are fried in vegetable oil for about 18 seconds at about 190° C.
13. The fried ovals are placed on a plate with paper towels for about 5 minutes, and then are placed in a plastic bag for analysis.
14. The samples are analyzed for % moisture and acrylamide. The moisture is about 2%. The results of the acrylamide analysis are shown in the table below.
   b. Potato Crisps Treated with Calcium Lactate

The procedure of part (a) is used except that 0.5 grams of calcium lactate pentahydrate is added to the water and emulsifier prior to homogenization. The samples are analyzed for % moisture and acrylamide. The moisture is about 2%. The results of the acrylamide analysis are shown in the table below.

Results of experiments 12(a) and (b).

| | | Acrylamide in the fried |
|---|---|---|
| Experiment | Description | crisps (ppb) |
| (a) | Control - Potato crisps | 3447 |
| (b) | 0.5 g calcium lactate added | 902 |

### EXAMPLE 13

### Dehydrated Potato Product

Russett Burbank potatoes are steamed for about 20 minutes (1200 sec), then drained and masked. About 500 g of the mashed potato is set aside to be used as a standard. In a small breaker, about 0.20 g of insoluble calcium hydroxide and about 0.46 g lactic acid are added to about 14 g of water, and stirred for about 1 minute (60 sec). After 1 minute (60 sec) of stirring the calcium hydroxide is dissolved, forming soluble calcium ion. The solution in the beaker is added to a second 500 g of mashed potato, along with about 1.1 grams Dimodam™ emulsifier (available from Danisco A/S, Copenhagen, Denmark) and mixed for about 1 minute. Both 500 g samples are spread out on cookie sheets, and are placed in an oven (Yamato®, model number DKN400) at 45° C. for about 8 hours (28,800 sec). The final material contains about 6% moisture. Both samples are ground separately in a pulverizer to produce a coarse powder. The powder is sieved through a U.S. 30 mesh sieve, and the material that is less than or equal to 30 mesh is collected as flakes. About 100 g of each sample is collected and set aside for later use as an ingredient. The sample treated with calcium contains a reduced level of acrylamide.

### EXAMPLE 14

### Potato Crisps

Materials

| | | |
|---|---|---|
| Potato starch | 8.0 | g |
| Potato flakes | 93.8 | g (from Example 13) |
| Water | 50.0 | g |
| Emulsifier | 1.0 | g |

(Note: the emulsifier is a mixture of mono-, di- and triglycerides)

Equipment
Food processor (Cuisinart®)
Pasta sheeter (made by Mercado® of Italy)
Dough oval cutter and cutting board
Fryer (Cecilware® Deep Fat Fryer model EL 120).
   Procedure
1. 200 ml beaker is placed on an electronic balance and tared.
2. The dry materials are weighed out (+0.02 g) in the 200 ml beaker.
3. The dry ingredients are added to the food processor vessel. The dry ingredients are then mixed for about 30 seconds.
4. 1.0 g of emulsifier is placed in a 100 ml beaker. 50 g water is added, and heated for about 20 seconds in a microwave oven.
5. The water is mixed with the emulsifier in the beaker with a homogenizer for approximately 5 seconds.
6. 42.0 g of the water-emulsifier mixture is added to the dry ingredients in the food processor vessel.
7. The food processor is turned on, and after about 30 seconds, it is stopped, opened, and scraped along the sides and bottom with a spatula.
8. The top is placed back on and run for about another 30 seconds (about 60 seconds total mix time).
9. The top cover of the food processor is then taken off, and the dough is placed into a feeder for the pasta sheeter. The pasta sheeter rolls are set at the narrowest possible setting.
10. The sheet is run through the pasta sheeter about 5 times, or until the sheet is about 0.5 mm thick.
11. Dough ovals are cut out from the dough sheet with the oval cutter on the cutting board.
12. The dough ovals are fried in vegetable oil for about 14 seconds in vegetable oil at about 190° C.
13. The fried ovals are placed on a plate with paper towels for about 5 minutes (300 sec), and then are placed in a placed bag for analysis.
   Two sets of fried potato crisps are made. One set is made using the untreated potato flakes of Example 13. The second set is made with the calcium-treated potato flakes of Example 13. The pH of the dough using the untreated flakes is about 6.3, and the pH of the dough using the calcium-treated flakes is about 6.2, showing a minimal effect on the dough pH for the calcium-treatment. The samples and the controls are analyzed for acrylamide using the method set forth herein. The acrylamide level in the untreated chips is about 3419 ppb, while the acrylamide level in the calcium treated chips is about 1292 ppb.

### EXAMPLE 15

### Potato Crisps

This example shows the ability of divalent and trivalent cations to reduce acrylamide formation in a formulated chip. Standard commercial potato flakes are used in this example.

For each experiment listed below, about 100 grams of potato flakes are mixed with about 73 grams of water for about 5 minutes (300 sec). In the cases where divalent or trivalent cation salts are used, these salts are added to the water and mixed and dissolved before the water is mixed with the potato flakes. For each case, the potato-water dough is crumbled in a bowl, and dried in a convection oven overnight at about 55° C. Upon conclusion of the drying, the potato crumbs contain about 6 to 7 percent moisture. These potato crumbs are then used in the procedure below to make potato crisps.

Materials

| | | |
|---|---|---|
| Potato starch | 8.0 | g |
| Potato crumbs | 93.8 | g |
| (from procedure | | |
| described above) | | |
| Water | 50.0 | g |
| Emulsifier | 0.8 | g |

(Note: the emulsifier is a mixture of mono-, di- and triglycerides)

Equipment
Food processor (Cuisinart®)
Pasta sheeter (made by Somerset Industries® Model CDR-1550)
Dough oval cutter and cutting board
Fryer (Cecilwareg Deep Fat Fryer model EL 120).
   a. Potato Crisp Control

This example uses potato crumbs that are made by mixing only water and potato flakes and drying overnight.

### Procedure

15. A 250 ml beaker is placed on an electronic balance and tared.
16. The dry materials are weighed out (+0.02 g) in the 250 ml beaker.
17. The dry ingredients are added to the food processor vessel. The ingredients are then mixed in the food processor for about 30 seconds.
18. About 0.8 g of emulsifier is added a 100 ml beaker. About 50 g water is added to the beaker, then the mixture is heated about 20 seconds in the microwave oven, or until melted.
19. The water-emulsifier mixture in the beaker is blended with a homogenizer for approximately 5 seconds.
20. The water-emulsifier mixture is added to the food processor vessel.
21. The food processor is started. After about 30 seconds, the food processor is stopped, the vessel is opened and the sides and bottom are scraped with a spatula.
22. The top of the vessel is placed back on and the food processor is run for about another 30 seconds (about 60 second total mix time).
23. The top cover of the food processor is taken off, and the dough is placed into a feeder for the pasta sheeter. The pasta sheeter rolls are set at the narrowest possible setting.
24. The sheet is run through the pasta sheeter about 5 times, or until the sheet is about 0.5 mm thick.
25. Dough ovals are cut out from the dough sheet with the oval cutter on the cutting board.
26. The dough ovals are fried in vegetable oil for about 18 seconds at about 190° C.
27. The fried ovals are placed on a plate with paper towels for about 5 minutes (300 sec), and then are placed in a plastic bag for analysis.
28. The samples are analyzed for % moisture and acrylamide. The moisture is about 2% The results of the acrylamide analysis are shown in the table below.
   b. Potato Crisps Using Potato Crumbs Treated with Divalent or Trivalent Cations

The procedure of part (a) is used except that divalent or trivalent cation salts are added to the water prior to mixing it with the potato flakes and drying to form potato crumbs. The samples are analyzed for % moisture and acrylamide. The moisture is about 2%. The table below shows the various amounts of potato flakes, water and salt used to make the potato crumbs for each case. The results of the acrylamide analysis for the fried potato crisps made from the potato crumbs are also shown in the table below.

| Divalent or | | Weight of | | Acrylamide in |
|---|---|---|---|---|
| trivalent cation | Weight of | potato | Weight of | the fried potato |
| salt added | salt | flakes | water | crisps (ppb) |
| None | 0 | 100 g | 73 g | 5054 |
| Calcium chloride | 0.66 g | 100 g | 73 g | 2542 |
| dihydrate | | | | |
| Zinc chloride | 0.61 | 100 g | 73 g | 1659 |
| Magnesium | 0.91 | 100 g | 73 g | 2595 |
| chloride | | | | |
| hexahydrate | | | | |
| Aluminum | 1.18 | 100 g | 73 g | 1089 |
| chloride | | | | |
| hexahydrate | | | | |

While particular embodiments of the present invention have been illustrated and described, it will be obvious to those skilled in the art that various other changes and modifications can be made without departing from the spirit and scope of the invention. It is therefore intended to cover in the appended claims all such changes and modifications that are within the scope of this invention.

1. A method for reducing the level of acrylamide in a dough-based food product, comprising adding a water soluble multivalent cation to said food product before heating.

2. The method of claim 1, wherein said water soluble multivalent cation is selected from the group consisting of calcium, zinc, magnesium, copper, aluminum, or mixtures thereof.

3. The method of claim 1, wherein said multivalent cation comprises calcium lactate.

4. The method of claim 1, wherein said multivalent cation comprises calcium chloride.

5. The method of claim 1 wherein said multivalent cation is not complexed or chelated.

6. The method of claim 1, comprising:
(1) adding a water soluble multivalent cation to a dough;
(2) forming a snack piece from the dough; and
(3) cooking the snack piece to form a fabricated snack.

7. The method of claim 6, wherein said water soluble multivalent cation comprises calcium lactate.

8. A method for reducing the level of acrylamide in a food product, comprising adding a water soluble multivalent cation to said food product before heating, wherein said water soluble multivalent cation is selected from the group consisting of zinc, magnesium, copper, aluminum, or mixtures thereof.

9. The method of claim 8, wherein said water soluble multivalent cation is not complexed or chelated.

10. The method of claim 8, comprising:
(I) adding a water soluble multivalent cation to a food material, wherein said food material comprises asparagine;
(2) optionally mixing the cation with the food material;
(3) allowing a sufficient time for the cation to complex; and
(4) heating the food material to form the finished food product.

11. The method of claim 8, comprising:
(1) optionally peeling potatoes;
(2) optionally washing potatoes;
(3) slicing potatoes to form potato slices;
(4) optionally rinsing the potato slices;
(5) optionally blanching the potato slices;
(6) optionally cooling the potato slices;
(7) adding a water soluble multivalent cation to the potato slices;
(8) optionally drying the potato slices;
(9) frying the potato slices to form potato chips.

12. The method of claim 8, comprising:
(1) optionally peeling potatoes;
(2) optionally washing potatoes;
(3) cutting potatoes to form potato strips;
(4) optionally rinsing the potato strips;
(5) optionally blanching the potato strips;
(6) optionally cooling the potato strips;
(7) adding a water soluble multivalent cation to the potato strips;
(8) optionally drying the potato strips;
(9) optionally coating the potato strips; and
(10) par-frying the potato strips to form par-fries.

13. The method of claim 8, comprising:
(1) cooking potatoes to form cooked potatoes;
(2) forming a wet mash from the cooked potatoes;
(3) adding a water soluble multivalent cation to the wet mash;
(4) drying the wet mash to form dehydrated potato products.

14. The method of claim 8, wherein said multivalent cation comprises calcium lactate.

15. The method of claim 8, wherein said multivalent cation comprises calcium chloride

16. The method of claim 1, wherein the acrylamide level is reduced by at least about 10%.

17. The method of claim 8, wherein the acrylamide level is reduced by at least about 10%.

18. The method of claim 1, wherein said adding a water soluble multivalent cation comprises adding a water insoluble multivalent cation and an acid.

19. The method of claim 18, wherein said water insoluble multivalent cation comprises calcium hydroxide and wherein said acid comprises lactic acid.

20. The method of claim 8, wherein said adding a water soluble multivalent cation comprises adding a water insoluble multivalent cation and an acid.

21. The method of claim 20, wherein said water insoluble multivalent cation comprises calcium hydroxide and wherein said acid comprises lactic acid.
